(19) United States
(12) Patent Application Publication
(10) Pub. No.: US 2018/0080538 A1
(43) Pub. Date: Mar. 22, 2018

(54) METHOD FOR PRODUCING A STATOR FOR A CAMSHAFT ADJUSTER

(71) Applicant: Miba Sinter Austria GmbH, Laakirchen (AT)

(72) Inventors: Dietmar GEBHART, Schwanenstadt (AT); Thomas KAISER, Vorchdorf (AT)

(73) Assignee: Miba Sinter Austria GmbH, Laakirchen (AT)

(21) Appl. No.: 15/672,396

(22) Filed: Aug. 9, 2017

(30) Foreign Application Priority Data
Sep. 22, 2016 (AT) A 50849/2016

(51) Int. Cl. F16H 55/06; F01L 1/344; F16H 55/17; B22F 5/08

(52) U.S. Cl. CPC F16H 55/06; B22F 5/08; F16H 55/17; F01L 1/344

(57) ABSTRACT

A method for producing a stator for a camshaft adjuster, the produced stator having an annular main body with outer spur toothing and with webs extending radially inwards from a radially inner surface of the main body spaced part from one another in the circumferential direction of the main body, includes the steps of providing a mold for forming the main body integrally with the spur toothing and the webs extending radially inwards, filling the mold with a metallic powder, pressing the powder to form a green compact and sintering the green compact to obtain a stator blank. The spur toothing, the surface of the main body facing radially inwards and formed between the webs as well as side faces of the webs adjoining the surface are compacted to the desired final dimensions in several steps without prior mechanical processing.

### CROSS REFERENCE TO RELATED APPLICATIONS

Applicant claims priority under 35 U.S.C. § 119 of Austrian Application No. A 50849/2016 filed on Sep. 22, 2016, the disclosure of which is incorporated by reference.

### BACKGROUND OF THE INVENTION

### 1. Field of the Invention

The invention relates to a method for producing a stator for a camshaft adjuster, the produced stator having an annular main body with spur toothing and with webs extending radially inwards from a radially inner surface of the main body spaced apart from one another in the circumferential direction of the main body, comprising the steps of providing a mold for forming the main body integrally with the spur toothing and the webs extending radially inwards, filling the mold with a metallic powder, pressing the powder to form a green compact and sintering the green compact to obtain a stator blank.

The invention further relates to a stator for a camshaft adjuster comprising an annular main body which has spur toothing on its external circumference and several mutually spaced webs extending radially inwards on an inner surface.

### 2. Description of the Related Art

Camshaft adjusters are used in a known manner for adjusting valve opening times with a view to obtaining greater efficiency of an internal combustion engine. Various different designs are known from the prior art. A hydraulic camshaft adjuster of the generic type comprises a stator in which a rotor is disposed. The rotor is connected to the camshaft so as to rotate in unison with it. The stator, which is connected to the crankshaft, has webs extending radially inwards which form the contact surfaces for the vanes of the rotor. Accordingly, the rotor is only able to rotate within a predefined angular range relative to the stator.

### SUMMARY OF THE INVENTION

The underlying objective of this invention is to make it easier to produce a stator for a camshaft adjuster and to propose a stator for a camshaft adjuster produced by the proposed method.

The objective of the invention is achieved on the basis of the aforementioned method due to the fact that the spur toothing, the surface of the main body facing radially inwards and formed between the webs as well as side faces of the webs adjoining the surface are compacted to the desired final dimensions in several steps without prior mechanical processing.

The objective of the invention is also achieved by the aforementioned stator, wherein the spur toothing, the surface of the main body facing radially inwards which is formed between the webs as well as the side faces of the webs adjoining the surface are subjected exclusively to a compaction process in terms of mechanical processing, and a density gradient is created from a surface in the direction towards a core layer.

As a result, the external toothing, the surface of the main body facing radially inwards which is formed between the webs as well as the side faces of the webs of the stator adjoining the surface are produced in near net-shape and/or in net-shape quality already during pressing and sintering of the powder. Accordingly, a surface compaction is all that is needed after sintering in order to improve the strength of the component. By avoiding mechanical processing of said surfaces of the stator—with the exception of the surface compaction—the latter can be produced more easily and by dispensing with mechanical processing to remove material, not only can the stator be produced more easily as such, the density of the hydraulic camshaft adjuster can also be improved and/or obtained more easily. Due to the method, the risk of swarf getting into the fluid system of the camshaft adjuster is also avoided. As a result of the multi-stage compaction of the surfaces, a density gradient is created in the direction towards the core layer of the stator which has an abrupt transition from the compacted to the non-compacted zone. This enables the properties of the stator to be better adapted to the requirements demanded of the camshaft adjuster. Operating the compaction process in steps also offers an advantage in that it can be followed by a surface hardening process. As a result, the depth of hardening can be more effectively adjusted so that the core layer can be left unhardened and thus has a corresponding toughness, which has a positive effect on the fracture behavior of the stator.

Based on one embodiment of the method, the radially inward facing surface of the main body and the side faces of the webs are compacted in a single process step. The processing time of the stator can therefore be reduced accordingly, thereby enabling production costs to be reduced.

It is also possible for the external toothing, the radially inward facing surface of the main body and the side faces of the webs to be compacted simultaneously, thereby enabling the aforementioned effects to be further enhanced.

Based on another embodiment of the method and/or stator, a hub may be provided between the webs and the spur toothing on which a second spur gear is or can be disposed, and a spur toothing of the second spur gear having the same geometry in terms of the cross-section of the teeth in the axial direction, the pitch and modulus is produced or formed. This means that when producing the sintered component, allowance can be made at the same time to incorporate a design of the stator for a so-called split gear so that the external toothing of the stator is able to locate without any clearance in the toothing of another gearwheel with which the stator connects in a meshing arrangement. The clearance-free arrangement prevents impacts on the teeth of the external toothing of the stator. This in turn has a positive effect on the durability of the teeth of the external toothing of the stator, which in the simplest case undergo “just” a surface compaction with a view to improving the strength of the component.

Alternatively, however, it is also possible for the spur toothing of the stator and the webs of the stator to be case hardened up to a depth of at most 1.5 mm before or after the compaction process so that the spur toothing and the webs have a surface hardness of at least 500 HV 5. This enables the strength of the component to be further improved. In this respect, it has been found that a depth of at most 0.4 mm is preferable because the component toughness in the core layer of the stator is better preserved.

### BRIEF DESCRIPTION OF THE DRAWINGS

To provide a clearer understanding, the invention will be explained in more detail below with reference to the drawings.

These are simplified, schematic diagrams illustrating the following:

FIG. 1 a part of a camshaft adjuster;

FIG. 2 a front view of the stator and rotor of the camshaft adjuster illustrated in FIG. 1;

FIG. 3 a section through one embodiment of a stator and rotor of a camshaft adjuster viewed from an angle;

FIG. 4 the stator and rotor illustrated in FIG. 3 with an additional spur gear.

### DETAILED DESCRIPTION OF PREFERRED EMBODIMENTS

Firstly, it should be pointed out that the same parts described in the different embodiments are denoted by the same reference numbers and same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

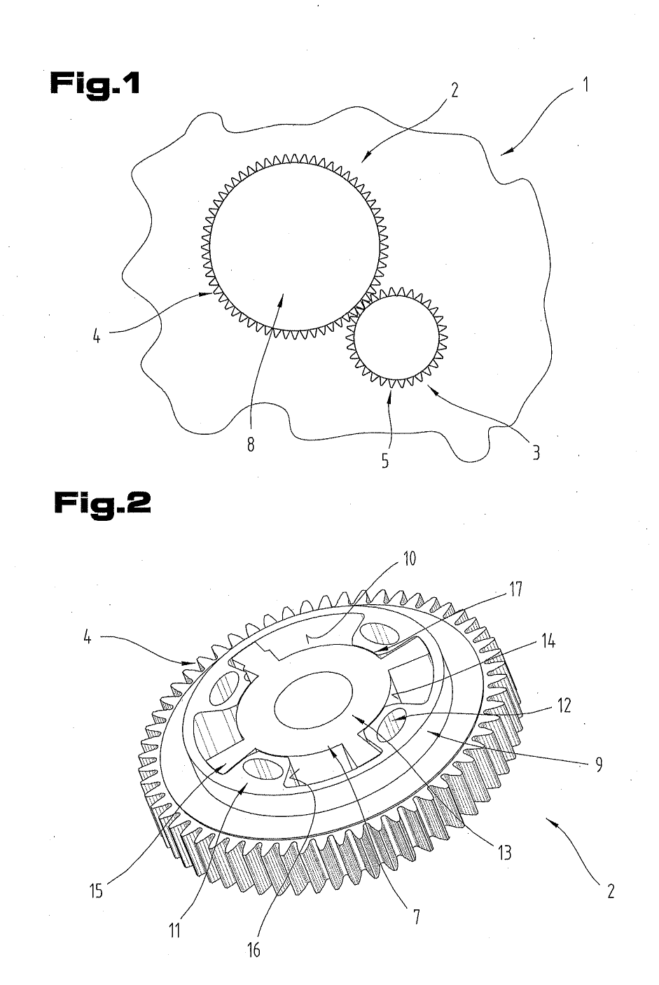

FIG. 1 illustrates part of an internal combustion engine 1. A camshaft adjuster 2 and a drive wheel 3 are illustrated. The camshaft adjuster 2 has spur toothing 4 on its external circumference. The drive wheel 3 likewise has spur toothing 5 on its external circumference. The two sets of spur toothing 4, 5 engage with one another in a meshing arrangement.

In principle, this design of hydraulic camshaft adjusters 2 is known from the prior art and needs no further explanation.

The camshaft adjuster 2 has a stator 6 and a rotor 7, as may be seen more clearly from FIG. 2, in which end-face covers 8 of the camshaft adjuster 2 (FIG. 1) are not illustrated.

The stator 6 has an annular main body 9, which—as already mentioned—has external toothing in the form of spur toothing 4 on its external circumference. On a radially inner surface 10 of the main body 9 and extending radially out from it are webs 11. In this specific case, the stator 6 has four webs 11. However, this number of webs 11 should not be construed as restrictive in any way. It would also be possible to provide more or fewer webs 11. If necessary, the webs 11 may be provided with a cut-out 12 or orifice, thereby reducing the weight of the stator 6. The webs 11 are spaced apart from one another in the circumferential direction on the main body 9 of the stator 6.

The stator 6 is an integral sintered component, which therefore means that the spur toothing 4 and webs 11 constitute a single sintered component integral with the main body 9.

Disposed inside the stator 6—as mentioned, the covers 8 are not illustrated (FIG. 1)—is the rotor 7. The rotor 7 likewise has a main body 13. Vanes 15 are provided or disposed on an external surface 14 of this main body 13, extending radially outwards starting from the surface 14. When the camshaft adjuster 2 is in the assembled state, these vanes 15 are disposed between the webs 11 of the stator 6. Side faces 16 of the webs 11 therefore serve as the contact surfaces for the vanes 15 of the rotor 7, as may be seen from FIG. 2.

The number of vanes 15 of the rotor 7 will depend on the number of webs 11 of the stator 6 and in this particular case there are therefore four vanes 15.

The rotor 7 is disposed inside the stator 6 so as to be rotatable relative thereto in the circumferential direction, the degree of rotatability being restricted by the webs 11.

The stator 6 is a sintered component, i.e. it is produced by a sintering process. To this end, a mold cavity of a mold is filled with a metallic powder, for example a sintered steel powder. The mold cavity is a negative mold of the stator 6. The metallic powder is then pressed to obtain a green compact and the green compact is sintered in one or a number of steps to obtain a stator blank. The principle behind such sintering processes has already been described in the prior art, to which reference may be made for further details of the sintering process.

After sintering, the stator blank is compacted in a number of steps, i.e. at least the outer spur toothing 4, the radially inward facing surface 10 of the main body 9 that was formed between the webs 11 and the side faces 16 of the webs 11 adjoining the surface 10. Other than this, these surfaces or regions of the stator blank are not subjected to any mechanical processing, especially mechanical processing involving the removal of material. Accordingly, using the proposed method for producing the stator 6, a stator 6 is produced which has spur toothing 4, a radially inward facing surface 10 of the main body 9 formed between the webs 11 and side faces 16 of the webs 11 adjoining the surface 10 of a quality that is near net-shape, in particular in net-shape, without additional mechanical processing (with the exception of compaction). The compaction therefore results in the desired final dimensions of said regions of the stator 6.

In particular, the compaction is carried out immediately after sintering so that the stator blank can be compacted whilst still warm if necessary. However, the stator blank may also be cooled beforehand.

Said compaction takes place in a number of steps. This being the case, the stator blank can be pressed by a number of compaction dies which are disposed one after the other in the production process. The inside diameter of the compaction dies decreases gradually, in particular in steps. A compaction die preferably has a constant inside diameter.

For the sake of completeness, it should be pointed out at this stage that the compaction dies have a contour corresponding to the spur toothing 5 of the stator blank.

However, the multi-step compaction takes place in a single compaction tool that has a number of sections of decreasing inside diameter. In this respect, sections having a constant inside diameter may be provided inside the compaction die. Based on this embodiment of the method, there is no pressure relief during compaction of the spur toothing 4 of the stator blank.

If the compaction process is operated with a reversal of movement of the stator blank through the compaction die, the stator blank can be relieved of pressure in one direction of movement after the last compaction step.

For the multi-step compaction of the radially inward facing surface 10 of the main body 9 that was formed between the webs 11 as well as the side faces 16 of the webs 11 adjoining the surface 10, an appropriate bar-shaped compaction tool is used, which is introduced into the stator blank. The multi-step compaction process may be operated using several of these bar-shaped compaction tools or using a single bar-shaped compaction tool, in a manner similar to the compaction of the spur toothing 4, but with the difference that the external cross-section of the bar-shaped compaction tools or the bar-shaped compaction tool becomes larger with increasing compaction of the stator blank.

It should be pointed out that the stator blank is supported during the compaction process, for example by means of a stamp. The stator blank may be clamped between a bottom stamp and a top stamp in particular during the compaction process.

Surfaces 17 of the webs 11 pointing radially inwards, in other words the radially innermost surfaces of the webs 11, may be mechanically finished if necessary, in particular by having material removed, although it would also be possible for these surfaces 17 to be produced to a quality that is near net-shape, in particular in net-shape, using the method described above.

Due to the multi-step compaction process, the stator 6 produced by the proposed method undergoes exclusively a compaction in terms of mechanical processing, at least in the region of the spur toothing 4, the radially inward facing surface 10 of the main body 9 that was formed between the webs 11 and the side faces 16 of the webs 11 adjoining the surface 10, and a density gradient is created from an outer surface in the direction towards a core layer of the stator 6. The core layer of the stator 6 is that region which has the density that was imparted to the green compact after pressing the powder. In other words, the core layer starts where the subsequent multi-step compaction ends.

Based on the preferred embodiment of the method, therefore, the spur toothing 4, the radially inward facing surface 10 of the main body 9 and the side faces 16 of the webs 11 of the stator are compacted in one work step. In the case of the spur toothing 4, this takes place by said compaction based on the decreasing inside diameter. The surface 10 and the side faces 16 can be compacted using the bar-shaped compaction tool with an increasing external cross-section. The multi-step compaction of the spur toothing 4 may take place before or after the multi-step compaction of the surface 10 and side faces 16.

At this stage, it should be pointed out that the expression “multi-step” should be construed in the sense of “multi-stage” if using only one compaction die or only one bar-shaped compaction tool.

Based on another embodiment of the method, the spur toothing 4, the radially inward facing surface 10 of the main body 9 and the side faces 16 of the webs 11 can be compacted simultaneously. To this end, the stator blank is introduced into the compaction die(s) and the bar-shaped compaction tool is introduced into the stator blank simultaneously.

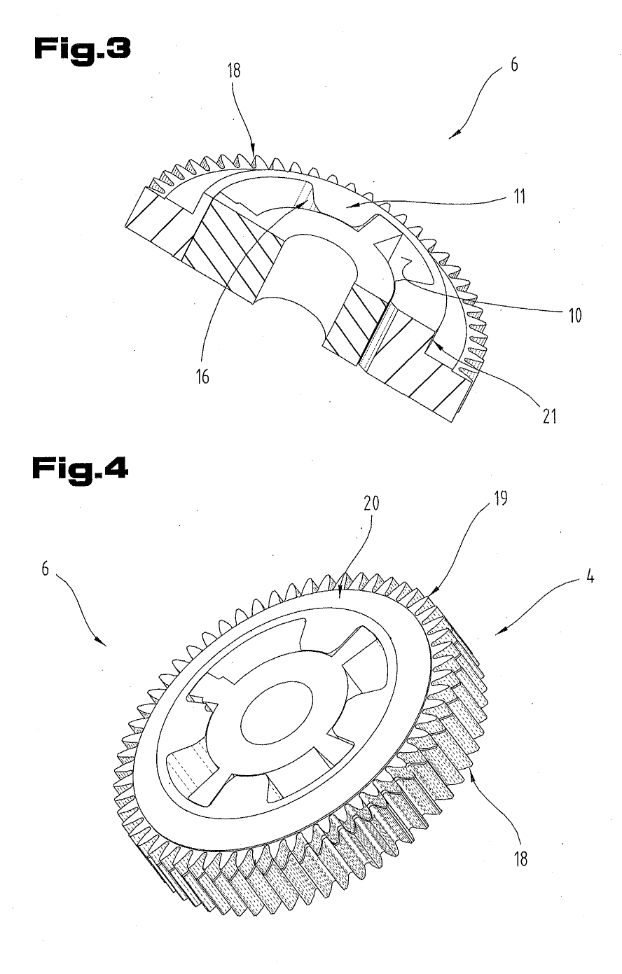

FIGS. 3 and 4 illustrate another optionally independent embodiment of the stator 6, the same reference numbers and component names being used to denote parts that are the same as those described with reference to FIGS. 1 and 2 above. To avoid unnecessary repetition, reference may be made to the more detailed descriptions of FIGS. 1 and 2 above.

Based on this embodiment of the stator 6, the spur toothing 4 (FIG. 2) is split into two parts in the axial direction. A first spur toothing part 18 is formed by the stator 6 described above, which means that in this embodiment, it constitutes only a first stator part and a second spur toothing part 19 is formed by another spur gear 20 constituting a second stator part. In addition to the first spur toothing part 18, the first stator part also comprises the surface 10 and the webs 11 with side faces 16 described above. The surface 10 and webs 11 have a longer length in the axial direction than the first spur toothing part 18.

To enable the other spur gear 20 to be fitted on the first stator part, an annular hub 21 is provided between the webs 11 and the first spur toothing part 18—as viewed in the radial direction. This hub 21 is already incorporated in the shape of the green compact for the stator 6 so that it is likewise an integral part of the first stator part.

In particular, the hub 21 is disposed directly adjoining the webs 11, i.e. directly above the webs 11 in the radial direction.

The other spur gear 20 has spur toothing which has the same geometry in terms of the cross-section of the teeth in the axial direction, the pitch and modulus. Accordingly, the design of the stator 6 is that of a so-called split gear to enable meshing of the toothing of the stator 6 in the spur toothing 5 of the drive wheel 3 free of play (FIG. 1). To this end, the other spur gear 20 is turned in the circumferential direction relative to the first stator part so that the first and second spur toothing parts 18, 19 are not disposed congruently in the axial direction. Furthermore, the other spur gear 20 is biased against the first stator part in the circumferential direction, for example by means of a so-called Ω-clip disposed between the first stator part and the other spur gear 20 in the axial direction and supported on cooperating projections on the first stator part and the other spur gear 20. As such designs of gears for eliminating backlash are known from the prior art, reference may be made to this prior art for further details.

With this two-part embodiment of the stator 6, the webs 11 preferably extend in the axial direction across the entire length of the stator 6 in the same direction.

Based on another embodiment of the method, the spur toothing 4 (or the two spur toothing parts 18, 19) and the webs of the stator 6 may be case hardened up to a depth of at most 1.5 mm before or after the multi-step compaction so that they have a surface hardness of at least 500 HV 5. However, it would also be possible for the stator 6 to be through hardened, at least in certain regions.

The embodiments illustrated as examples represent possible variants and it should be pointed out that different combinations of the individual embodiments with one another are also possible.

For the sake of good order, finally, it should be pointed out that, in order to provide a clearer understanding of the structure of the stator 6 and/or camshaft adjuster 2, the latter are not necessarily illustrated to scale.

### LIST OF REFERENCE NUMBERS

1 Internal combustion engine
2 Camshaft adjuster
3 Drive wheel
4 Spur toothing
5 Spur toothing
6 Stator
7 Rotor
8 Cover
9 Main body
10 Surface
11 Web
12 Cut-out
13 Main body
14 Surface
15 Vane
16 Side face
17 Surface
18 Spur toothing part
19 Spur toothing part
20 Spur gear
21 Hub

1. Method for producing a stator (6) for a camshaft adjuster (2), the produced stator (6) having an annular main body (9) with outer spur toothing (4) and with webs (11) extending radially inwards from a radially inner surface (10) of the main body (9) spaced apart from one another in the circumferential direction of the main body (9), comprising the steps of providing a mold for forming the main body (9) integrally with the spur toothing (4) and the webs (11) extending radially inwards, filling the mold with a metallic powder, pressing the powder to form a green compact and sintering the green compact to obtain a stator blank, wherein the spur toothing (4), the surface (10) of the main body (9) facing radially inwards and formed between the webs (11) as well as side faces (16) of the webs (11) adjoining the surface (10) are compacted to the desired final dimensions in several steps without prior mechanical processing.

2. Method according to claim 1, wherein the spur toothing (4), the radially inward facing surface (10) of the main body (9) and the side faces (16) of the webs (11) are compacted in one work step.

3. Method according to claim 1, wherein the spur toothing (4), the radially inward facing surfaces (10) of the main body (9) and the side faces (16) of the webs (11) are compacted simultaneously.

4. Method according to claim 1, wherein a hub (21) is provided between the webs (11) and the spur toothing (4) on which a second spur gear (20) is disposed, and a spur toothing (4) of the second spur gear (20) having the same geometry in terms of the cross-section of the teeth in the axial direction, the pitch and modulus as the spur toothing (4) is produced.

5. Method according to claim 1, wherein the spur toothing (4) of the stator (6) and the webs (11) of the stator (6) are case hardened up to a depth of at most 1.5 mm before or after the compaction process.

6. Stator (6) for a camshaft adjuster (2) comprising an annular main body (9) having spur toothing (4) on its external circumference and a number of mutually spaced webs (11) on an inner surface (10) extending radially inwards, wherein the spur toothing (4), the radially inward facing surface (10) of the main body (9) formed between the webs (11) as well as side faces (16) of the webs (11) adjoining the surface (10) are subjected exclusively to a compaction process in terms of mechanical processing, and a density gradient is created from a surface in the direction towards a core layer.

7. Stator (6) according to claim wherein a hub (21) is provided between the spur toothing (4) and the webs (11) on which a second spur gear (20) is disposed, and a spur toothing (4) of the second spur gear (20) has the same geometry in terms of the cross-section of the teeth in the axial direction, the pitch and modulus as the spur toothing (4), and the second spur gear (20) is disposed rotated in the circumferential direction relative to the spur toothing (4) and is biased.

8. Stator according to claim 6, wherein the spur toothing (4) and the webs (11) have a surface hardness of at least 500 HV 5.
